(19) United States
(12) Patent Application Publication
(10) Pub. No.: US 2024/0324020 A1
(43) Pub. Date: Sep. 26, 2024

(54) SMALL DATA TRANSFER COMMUNICATIONS

(71) Applicant: QUALCOMM Incorporated, San Diego, CA (US)

(72) Inventor: Ruiming ZHENG, Beijing (CN)

(21) Appl. No.: 18/578,206

(22) PCT Filed: Aug. 6, 2021
(86) PCT No.: PCT/CN2021/111192

§ 371 Date: Jan. 10, 2024

(51) Int. Cl. H04W 74/0833; H04W 72/115; H04W 72/1268; H04W 76/27

(52) U.S. Cl. CPC H04W 74/0833; H04W 72/115; H04W 72/1268; H04W 76/27

(57) ABSTRACT

Various aspects of the present disclosure generally relate to wireless communication. In some aspects, a user equipment (UE) may transmit an uplink message, via a configured grant, while the UE is in an inactive state, the uplink message including a request to resume a connection and uplink data. The UE may initiate a random access channel (RACH) procedure based at least in part on the configured grant being unsuitable for subsequent transmissions of the uplink data. The UE may transmit at least a portion of the uplink data via a message of the RACH procedure. Numerous other aspects are described.

### FIELD OF THE DISCLOSURE

Aspects of the present disclosure generally relate to wireless communication and to techniques and apparatuses for small data transfer communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting an uplink message, via a configured grant, while the UE is in an inactive state, the uplink message including a request to resume a connection and uplink data. The method may include initiating a random access channel (RACH) procedure based at least in part on the configured grant being unsuitable for subsequent transmissions of the uplink data. The method may include transmitting at least a portion of the uplink data via a message of the RACH procedure.

Some aspects described herein relate to a UE for wireless communication. The user equipment may include memory, one or more processors coupled to the memory, and instructions stored in the memory and executable by the one or more processors. The instructions may be executable by the one or more processors to cause the user equipment to transmit an uplink message, via a configured grant, while the UE is in an inactive state, the uplink message including a request to resume a connection and uplink data. The instructions may be executable by the one or more processors to cause the user equipment to initiate a RACH procedure based at least in part on the configured grant being unsuitable for subsequent transmissions of the uplink data. The instructions may be executable by the one or more processors to cause the user equipment to transmit at least a portion of the uplink data via a message of the RACH procedure.

Some aspects described herein relate to a non-transitory computer-readable medium that stores a set of instructions for wireless communication. The set of instructions, when executed by one or more processors of the UE cause the UE to transmit an uplink message, via a configured grant, while the UE is in an inactive state. The uplink message includes a request to resume a connection and uplink data. The set of instructions, when executed by one or more processors of the UE further cause the UE to initiate a RACH procedure based at least in part on the configured grant being unsuitable for subsequent transmissions of the uplink data. The set of instructions, when executed by one or more processors of the UE further cause the UE to transmit at least a portion of the uplink data via a message of the RACH procedure.

Some aspects described herein relate to an apparatus for wireless communication. The apparatus may include means for transmitting an uplink message, via a configured grant, while the UE is in an inactive state, the uplink message including a request to resume a connection and uplink data. The apparatus may include means for initiating a RACH procedure based at least in part on the configured grant being unsuitable for subsequent transmissions of the uplink data. The apparatus may include means for transmitting at least a portion of the uplink data via a message of the RACH procedure.

Aspects generally include a method, apparatus, system, computer program product, non-transitory computer-readable medium, user equipment, base station, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating examples of random access channel-based small data transfer (SDT) procedures, in accordance with the present disclosure.

FIG. 4 is a diagram illustrating examples of a configured grant-based SDT procedure, in accordance with the present disclosure.

FIGS. 5-8 are diagrams illustrating examples associated with small data transfer communications, in accordance with the present disclosure.

FIG. 9 is a diagram illustrating an example process associated with small data transfer communications, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

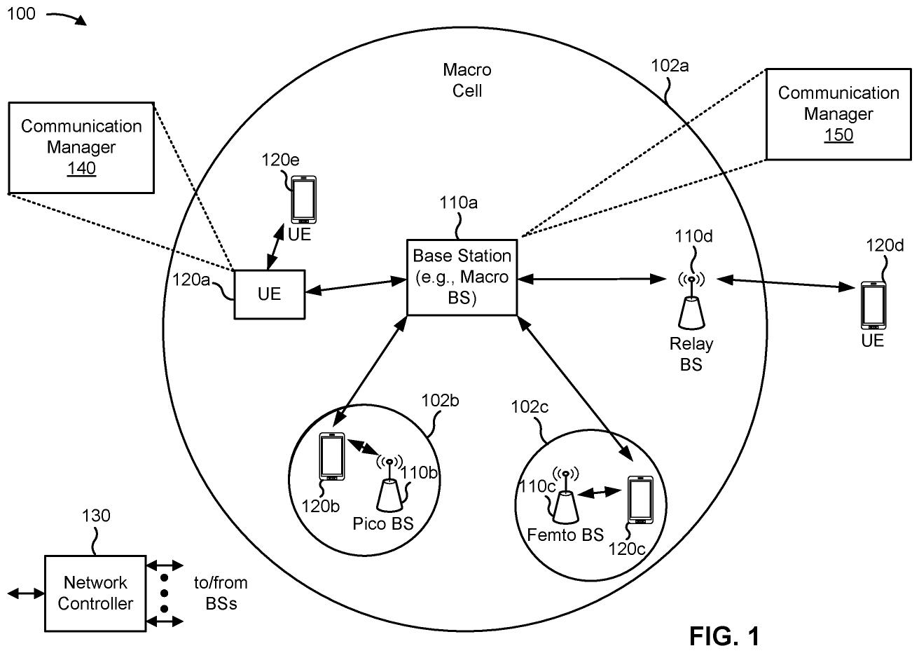

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHZ-52.6 GHz). It should be understood that although a portion of FR1 is greater than 6 GHZ, FRI is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FRI, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FRI, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit an uplink message, via a configured grant, while the UE is in an inactive state, the uplink message including a request to resume a connection and uplink data; and initiate a RACH procedure based at least in part on the configured grant being unsuitable for subsequent transmissions of the uplink data; and transmit at least a portion of the uplink data via a message of the RACH procedure. Additionally, or alternatively, the communication manager 140 may perform one or more other operations described herein.

As indicated above, FIG. 1 is provided as an example. Other examples may differ from what is described with regard to FIG. 1.

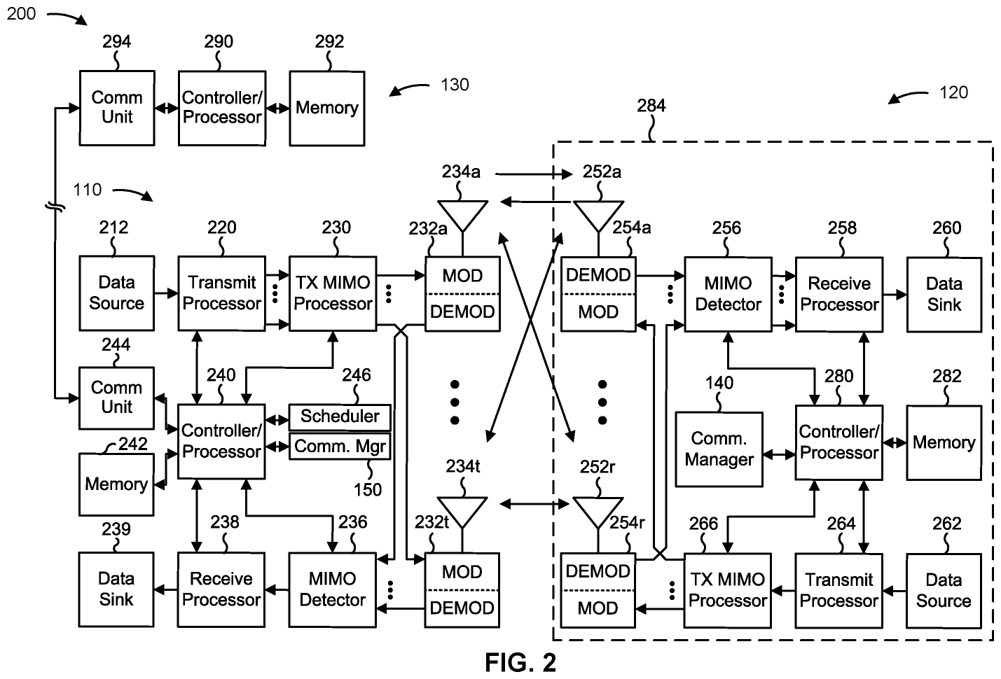

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

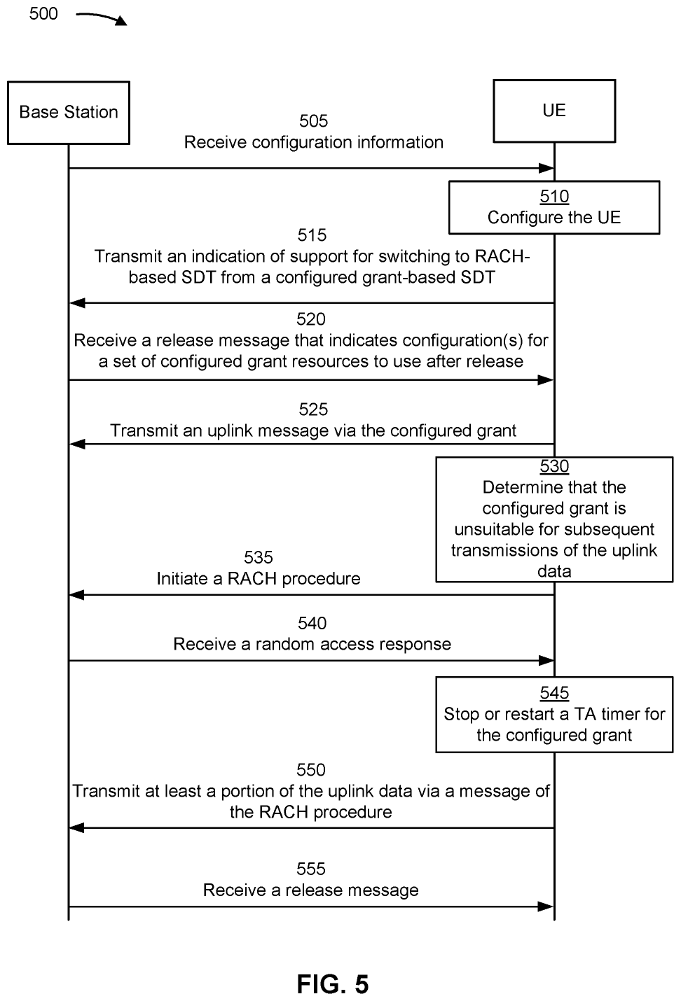

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-10).

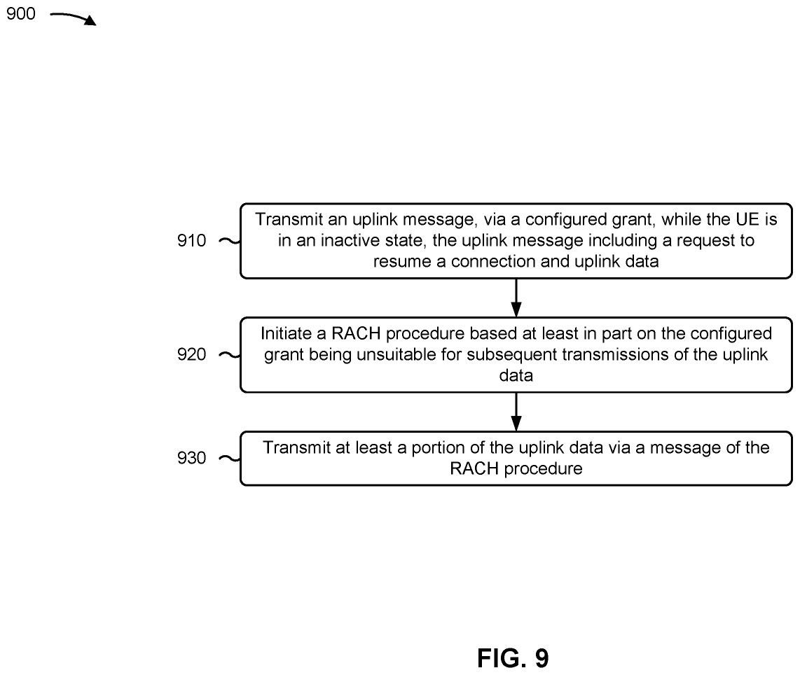

The controller/processor 240 of the base station 110, the controller/processor 280 of the UE 120, and/or any other component(s) of FIG. 2 may perform one or more techniques associated with small data transfer communications, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9 and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9 and/or other processes as described herein. In some examples, executing instructions may include running the instructions, converting the instructions, compiling the instructions, and/or interpreting the instructions, among other examples.

In some aspects, the UE includes means for transmitting an uplink message, via a configured grant, while the UE is in an inactive state, the uplink message including a request to resume a connection and uplink data; and/or means for initiating a RACH procedure based at least in part on the configured grant being unsuitable for subsequent transmissions of the uplink data; and/or means for transmitting at least a portion of the uplink data via a message of the RACH procedure. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

In some networks, a UE may be configured to communicate using small data transfers (SDTs) when the UE is in an inactive mode (e.g., radio resource control (RRC) inactive) without first transitioning to an RRC connected state. The UE may use an SDT process to transmit small amounts of data across a burst in a data session. The UE may use the SDT process in a mobile broadband (MBB), internet of things (IoT), and/or other communication environments. The SDT process may be used to transmit small amounts of data associated with messaging applications, social media applications, and/or wearable IoT device applications, among other examples.

In an SDT process, the UE may use a RACH-based SDT procedure (e.g., using a 2-step RACH or a 4-step RACH) or a configured grant-based procedure (e.g., using resources configured before transitioning to the inactive mode). After a first uplink message, the UE may continue to transmit subsequent transmissions of uplink data and/or to receive downlink data (e.g., in response to the uplink data). The UE may continue to transmit the subsequent transmissions of uplink data using a (user) Data radio bearer (DRB) associated with SDT. The DRB may be resumed based at least in part on the UE indicating a request to resume during the SDT procedure. A base station may determine whether the UE is to transition to an RRC connected state based at least in part on the subsequent transmissions.

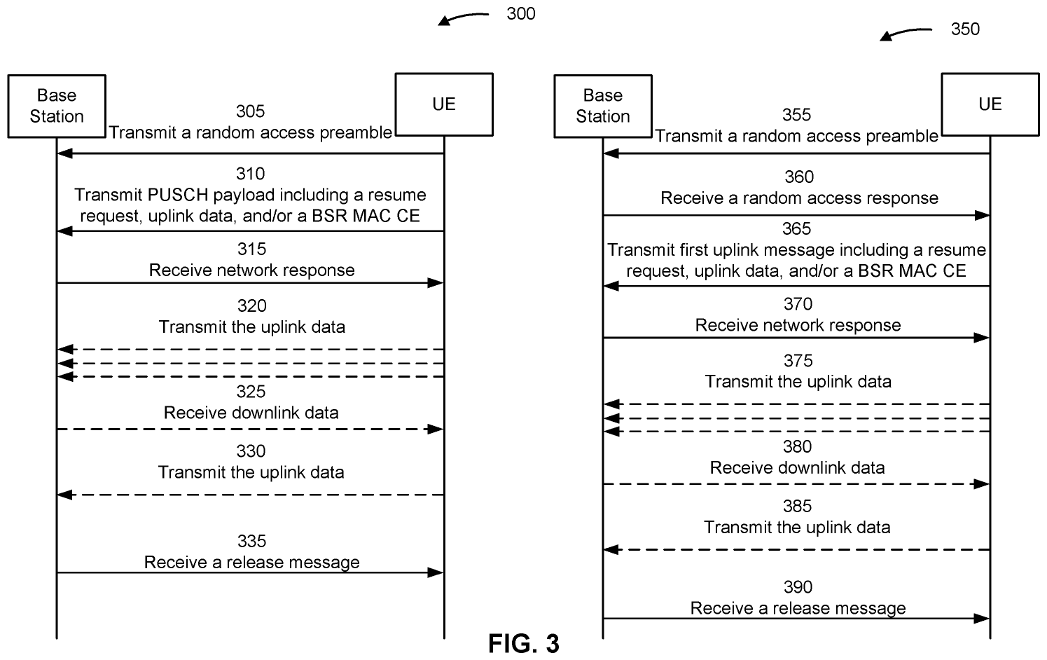

FIG. 3 is a diagram illustrating examples 300 and 350 of RACH-based SDT procedures, in accordance with the present disclosure. As shown in FIG. 3, a base station may communicate with a UE. In some aspects, the base station and the UE may be part of a wireless network. The UE and the base station may have established a wireless connection prior to operations shown in FIG. 3. Example 300 includes a 2-step RACH-based SDT process and example 350 includes a 4-step RACH-based SDT process.

As shown by reference number 305, the UE may transmit, and the base station may receive, a random access preamble. Transmission of the random access preamble may initiate the RACH-based SDT process. For example, the UE may transmit the random access preamble via SDT-based resources to indicate that the UE requests to initiate a RACH-based SDT process.

As shown by reference number 310, the UE may transmit, and the base station may receive, a physical uplink shared channel (PUSCH) payload that includes a resume request message (e.g., an RRCResumeReq), uplink data (e.g., SDT data), and/or a buffer status report (BSR) via one or more medium access control (MAC) control elements (MAC CEs). The transmission of the PUSCH payload may comprise a transmission of a message A of the RACH-based SDT process.

As shown by reference number 315, the UE may receive a network response. The network response may indicate a contention resolution for the random access preamble. The network response does not include an RRC message (e.g., an RRCConnect or RRCReconnect message, among other examples) based at least in part on the UE not being in a connected state.

As shown by reference number 320, the UE may transmit, and the base station may receive, the uplink data via one or more subsequent data transmissions. For example, the UE may transmit additional portions of the uplink data and/or the UE may re-transmit a portion of the uplink data transmitted in connection with reference number 310.

As shown by reference number 325, the UE may receive, and the base station may transmit, downlink data via one or more downlink transmissions associated with the RACH-based SDT. For example, the one or more downlink transmissions may be in response to the uplink data.

As shown by reference number 330, the UE may transmit the uplink data (e.g., an additional portion of the uplink data) in response to receiving the downlink data.

As shown by reference number 335, the UE may receive a release message (e.g., an RR(Release message). The release message may indicate a suspended configuration and/or may terminate the RACH-based SDT procedure.

Referring to example 350, as shown by reference number 355, the UE may transmit, and the base station may receive, a random access preamble as part of a 4-step RACH-based SDT process. Transmission of the random access preamble may initiate the RACH-based SDT process. For example, the UE may transmit the random access preamble via SDT-based resources to indicate that the UE requests to initiate a RACH-based SDT process. Transmission of the random access preamble may comprise a transmission of a message 1 of the RACH-based SDT process.

As shown by reference number 360, the UE may receive, and the base station may transmit, a random access response to the random access preamble. The random access response may acknowledge receipt of the random access preamble. Receiving the random access response may comprise a reception of a message 2 of the RACH-based SDT process.

As shown by reference number 365, the UE may transmit, and the base station may receive, a first uplink message that includes a resume request message (e.g., an RRCResumeReq), uplink data (e.g., SDT data), and/or a BSR via one or more MAC CEs. Transmitting the first uplink message may comprise a transmission of a message 3 of the RACH-based SDT process.

As shown by reference number 370, the UE may receive a network response. The network response may indicate a contention resolution for the random access preamble. The network response does not include an RRC message (e.g., an RRCConnect or RRCReconnect message, among other examples) based at least in part on the UE not being in a connected state. Receiving the network response may comprise a reception of a message 4 of the RACH-based SDT process.

As shown by reference number 375, the UE may transmit, and the base station may receive, the uplink data via one or more subsequent data transmissions. For example, the UE may transmit additional portions of the uplink data and/or the UE may re-transmit a portion of the uplink data transmitted in connection with reference number 365.

As shown by reference number 380, the UE may receive, and the base station may transmit, downlink data via one or more downlink transmissions associated with the RACH-based SDT. For example, the one or more downlink transmissions may be in response to the uplink data.

As shown by reference number 385, the UE may transmit the uplink data (e.g., an additional portion of the uplink data) in response to receiving the downlink data.

As shown by reference number 390, the UE may receive a release message (e.g., an RR(Release message). The release message may indicate a suspended configuration and/or may terminate the RACH-based SDT procedure.

As indicated above, FIG. 3 is provided as an example. Other examples may differ from what is described with regard to FIG. 3.

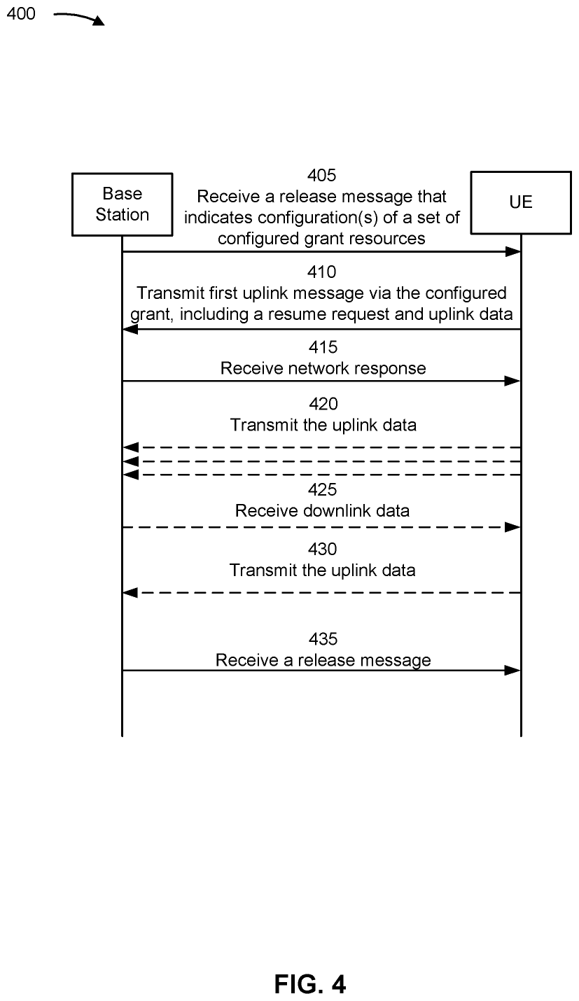

FIG. 4 is a diagram illustrating examples of a configured grant-based SDT procedure, in accordance with the present disclosure. As shown in FIG. 4, a base station may communicate with a UE. In some aspects, the base station and the UE may be part of a wireless network. The UE and the base station may have established a wireless connection prior to operations shown in FIG. 4.

As shown by reference number 405, the UE may receive, and the base station may transmit, a release message (e.g., RRCRelease) that indicates one or more configurations of a set of configured grant resources. For example, the configured grant may indicate resources configured to be used by the UE for SDT communications when the UE is in an inactive state.

As shown by reference number 410, the UE may transmit, and the base station may receive, a first uplink message via the configured grant that includes a resume request message (e.g., an RRCResumeReq) and uplink data (e.g., SDT data).

As shown by reference number 415, the UE may receive a network response. The network response may indicate an acknowledgment of the first uplink message and/or may request a re-transmission of the first uplink message. The network response does not include an RRC message (e.g., an RRCConnect or RRCReconnect message, among other examples) based at least in part on the UE not being in a connected state.

As shown by reference number 420, the UE may transmit, and the base station may receive, the uplink data via one or more subsequent data transmissions. For example, the UE may transmit additional portions of the uplink data, and/or the UE may re-transmit a portion of the uplink data transmitted in connection with reference number 410.

As shown by reference number 425, the UE may receive, and the base station may transmit, downlink data via one or more downlink transmissions associated with the RACH-based SDT. For example, the one or more downlink transmissions may be in response to the uplink data.

As shown by reference number 430, the UE may transmit the uplink data (e.g., an additional portion of the uplink data) in response to receiving the downlink data.

As shown by reference number 435, the UE may receive a release message (e.g., an RRCRelease message). The release message may indicate a suspended configuration and/or may terminate the RACH-based SDT procedure.

As indicated above, FIG. 4 is provided as an example. Other examples may differ from what is described with regard to FIG. 4.

In some networks, a UE may use a configured grant resource to transmit uplink data via a configured grant-based SDT. If transmission of the uplink data fails (e.g., the base station does not receive the uplink data), the UE may not receive a network response. For example, link degradation may cause the transmission of the uplink data to fail.

In some examples, a timing alignment associated with the configured grant may become invalid for a next configured grant occasion in a subsequent configured grant transmission phase. If the timing alignment is invalid, the UE may be prohibited from using the configured grant resources for transmitting uplink data.

In some examples, a best serving beam (e.g., based at least in part on measurements of synchronization signal blocks) may change before the subsequent configured grant transmission phase and/or a currently configured beam may be unsuitable for SDT (e.g., based at least in part on a poor link in a direction of the currently configured beam).

Based at least in part on the configured grant being unsuitable for subsequent transmissions of uplink data (e.g., based at least in part on an invalid timing alignment and/or an unsuitable configured beam, among other examples), the UE may fail to transmit data buffered for transmission via the configured grant resources. In this way, the UE may fail to transmit and/or receive data while in an inactive mode and/or the data may be expired before transmission and/or reception. The UE and the base station may consume computing, network, communication, and/or power resources to detect and/or recover from failures of the configured grant for transmission and/or reception of data while the UE is in an inactive mode.

In some aspects described herein, the UE may determine that a configured grant is unsuitable for subsequent transmissions (e.g., after transmission of a first message) of SDT-based data. For example, the UE may determine that the configured grant, in a subsequent configured grant SDT transmission phase, is unsuitable for subsequent transmissions of uplink data. The configured grant may be unsuitable based at least in part on a timing alignment associated with the configured grant becoming invalid and/or not having a qualified synchronization signal block (SSB) when an evaluation is performed before a subsequent transmission of the uplink data, among other examples. In some aspects, the UE may determine that the configured grant is unsuitable based at least in part on the UE having failed transmitting on the configured grant resource for a number of consecutive attempts to transmit. In some aspects, the UE may determine that the configured grant is unsuitable based at least in part on the UE receiving data that triggers a BSR when the configured grant does not have a scheduling request resource available.

Based at least in part on the configured grant being unsuitable for subsequent transmissions of the uplink data, the UE may initiate a RACH procedure. The UE may then transmit at least a portion of the uplink data via a message of the RACH procedure. The RACH procedure may include a standard RACH procedure (e.g., non-SDT) or an SDT-based RACH procedure. In this way, the UE may switch to a RACH procedure to transmit SDT data when the configured grant is unsuitable. The UE and the base station may conserve computing, network, communication, and/or power resources that may have otherwise been used to detect and/or recover from failures of the configured grant for transmission and/or reception of data while the UE is in an inactive mode.

FIG. 5 is a diagram illustrating an example 500 associated with small data transfer communications, in accordance with the present disclosure. As shown in FIG. 5, a base station (e.g., base station 110) may communicate with a UE (e.g., UE 120). In some aspects, the base station and the UE may be part of a wireless network (e.g., wireless network 100). The UE and the base station may have established a wireless connection prior to operations shown in FIG. 5.

As shown by reference number 505, the base station may transmit, and the UE may receive, configuration information. In some aspects, the UE may receive the configuration information via one or more of RRC signaling, MAC CEs, and/or downlink control information (DCI), among other examples. In some aspects, the configuration information may include an indication of one or more configuration parameters (e.g., already known to the UE) for selection by the UE, and/or explicit configuration information for the UE to use to configure the UE, among other examples.

In some aspects, the configuration information may indicate that the UE is to switch to a RACH-based SDT process from a configured grant-based SDT process based at least in part on the configured grant-based SDT being unsuitable for subsequent transmission of uplink data.

As shown by reference number 510, the UE may configure the UE based at least in part on the configuration information. In some aspects, the UE may be configured to perform one or more operations described herein based at least in part on the configuration information.

As shown by reference number 515, the UE may transmit, and the base station may receive, an indication of support for switching to a RACH-based SDT process from a configured grant-based SDT process. In some aspects, the UE may transmit the indication of support as part of an RRC connection procedure. For example, the UE may transmit the indication of support within a capabilities report.

As shown by reference number 520, the UE may receive a release message (e.g., RR(Release) that indicates one or more configurations for a set of configured grant resources to use after release of an active connection between the UE and the base station. In some aspects, the configured grant may include periodic resources that the UE may use for SDT communications. In some aspects, the release message also indicates that the UE is to transition to an inactive mode (e.g., RRCInactive).

As shown by reference number 525, the UE may transmit an uplink message via the configured grant. For example, the UE may transmit a portion of uplink data via resources associated with the configured grant. The UE may transmit the uplink message while the UE is in an inactive state. In some aspects, the uplink message includes a request to resume a connection (e.g., RRCResumeReq) and the uplink data.

As shown by reference number 530, the UE may determine that the configured grant is unsuitable for subsequent transmissions of the uplink data (e.g., subsequent transmissions of additional portions of the uplink data and/or re-transmissions of the uplink data). In some aspects, the configured grant is unsuitable for the subsequent transmissions of the uplink data based at least in part on a timing alignment value being invalid (e.g., expired), a change in RSRP (e.g., a degradation), and/or failure to detect a qualified synchronization signal block before the subsequent transmissions of the uplink data. In some aspects, the configured grant is unsuitable for the subsequent transmissions of the uplink data based at least in part on timing of a subsequent transmission occasion of the configured grant, a periodicity of transmission occasions of the configured grant, and/or a latency requirement of the subsequent transmissions of the uplink data. For example, timing of the subsequent transmission occasion of the configured grant may be too late for transmission of the uplink data based at least in part on the latency requirement of the uplink data. In some aspects, the configured grant is unsuitable for the subsequent transmissions of the uplink data based at least in part on a size of transmission occasions of the configured grant and/or an expected size of the subsequent transmissions of the uplink data, among other examples. For example, the uplink data may be too large to transmit via the transmission occasions of the configured grant.

In some aspects, the configured grant is unsuitable for the subsequent transmissions of the uplink data based at least in part on a failure of the uplink message. The UE may determine that the uplink message has failed based at least in part on an indication that the uplink message was not successfully received by a base station, a failure to receive a network response to the uplink message before expiration of a response timer, or satisfaction of a threshold number of failures of uplink messages using the configured grant.

As shown by reference number 535, the UE may initiate a RACH procedure. The UE may initiate the RACH procedure based at least in part on the configured grant being unsuitable for subsequent transmissions of the uplink data. In some aspects, the UE may initiate the RACH procedure using an uplink carrier configured the configured grant. Alternatively, the UE may perform uplink carrier selection.

The RACH procedure may include a 2-step RACH procedure, a 4-step RACH procedure, an SDT RACH procedure, and/or a non-SDT RACH procedure, among other examples.

In some aspects, the UE may select a RACH-based SDT procedure as the RACH procedure based at least in part on whether a size of the uplink data satisfies an SDT volume threshold and/or whether a signal strength parameter (e.g., RSRP among other examples) satisfies an SDT signal strength threshold. In some aspects, the UE may initiate the RACH procedure using a RACH occasion or a physical RACH resource associated with the RACH-based SDT procedure to indicate a request to use the RACH-based SDT procedure instead of a standard RACH procedure. Alternatively, the UE may select a standard (e.g., non-SDT) RACH procedure.

As shown by reference number 540, the UE may receive a random access response. In some aspects, the network response may indicate a contention resolution for the random access preamble. The network response does not include an RRC message (e.g., an RRCConnect or RRCReconnect message, among other examples) based at least in part on the UE not being in a connected state.

As shown by reference number 545, the UE may stop a timing alignment timer for the configured grant or restart the timing alignment timer for the configured grant. In some aspects, a resource associated with the configured grant is valid based at least in part on restarting the timing alignment timer for the configured grant. The UE may determine to use the valid resource for subsequent SDT transmitting of the uplink data using the configured grant SDT procedure.

As shown by reference number 550, the UE may transmit, and the base station may receive, at least a portion of the uplink data via a message of the RACH procedure. The message of the RACH procedure may be a RACH message 3 (e.g., for a 4-step RACH procedure) or a RACH message A (e.g., for a 2-step RACH procedure). In some aspects, the message of the RACH procedure may include an indication of an identification of the UE (e.g., a Cell Radio Network Temporary Identifier (C-RNTI)), a BSR, and/or uplink data without a request to resume the connection. In some aspects (e.g., where the first uplink message failed), the message of the RACH procedure may include a request to resume the connection, a BSR, and/or uplink data.

As shown by reference number 555, the UE may receive, and the base station may transmit, a release message. The release message may indicate a suspended configuration and/or may terminate the RACH-based SDT procedure.

Based at least in part on the UE being configured to switch to a RACH procedure to transmit SDT data when the configured grant is unsuitable, the UE and the base station may conserve computing, network, communication, and/or power resources that may have otherwise been used to detect and/or recover from failures of the configured grant for transmission and/or reception of data while the UE is in an inactive mode.

As indicated above, FIG. 5 is provided as an example. Other examples may differ from what is described with regard to FIG. 5.

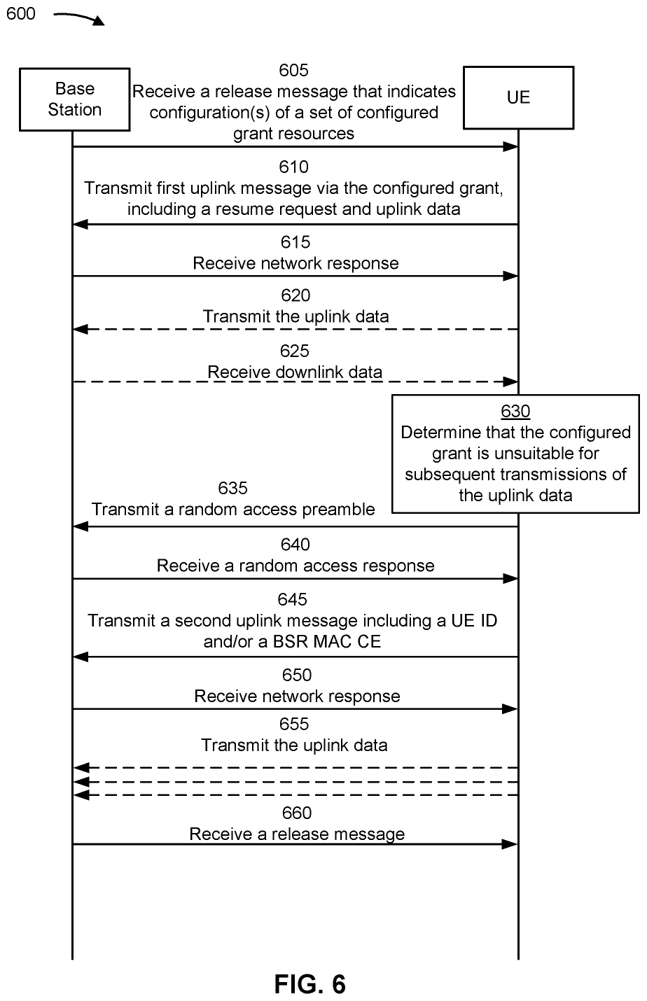

FIG. 6 is a diagram illustrating an example 600 associated with small data transfer communications, in accordance with the present disclosure. As shown in FIG. 6, a base station (e.g., base station 110) may communicate with a UE (e.g., UE 120). In some aspects, the base station and the UE may be part of a wireless network (e.g., wireless network 100). The UE and the base station may have established a wireless connection prior to operations shown in FIG. 6.

As shown by reference number 605, the UE may receive, and the base station may transmit, a release message that indicates a configuration of a configured grant, as described herein.

As shown by reference number 610, the UE may transmit, and the base station may receive, a first uplink message via the configured grant, including a resume request message and uplink data, as described herein.

As shown by reference number 615, the UE may receive, and the base station may transmit, a network response, as described herein.

As shown by reference number 620, the UE may transmit, and the base station may receive, the uplink data, as described herein.

As shown by reference number 625, the UE may receive, and the base station may transmit, downlink data, as described herein.

As shown by reference number 630, the UE may determine that the configured grant is unsuitable for subsequent transmissions of the uplink data, as described herein.

As shown by reference number 635, the UE may transmit, and the base station may receive, a random access preamble, as described herein. In some aspects, the UE does not check criteria for selecting between a non-SDT RACH-based procedure and an SDT RACH-based procedure. In some aspects, the UE selects the non-SDT RACH-based procedure based at least in part on one or more criteria, as described herein. The UE may transmit the random access preamble using a configured RACH occasion and a configured physical RACH (PRACH) resource.

The UE selects between a supplemental uplink (SUL) or a normal uplink (NUL) resource and/or a 2-step RACH or a 4-step RACH based at least in part on one or more parameters and/or a configuration of the network. In some aspects, the UE may select a different uplink carrier for the RACH-based procedure than an uplink carrier configured for the configured grant.

As shown by reference number 640, the UE may receive, and the base station may transmit, a random access response, as described herein. After the UE receives the random access response (e.g., an RAR or a message B, among other examples), the UE may apply a timing advance command to start a timing alignment parameter for the RACH procedure. Based at least in part on receiving the random access response, the UE may restart a timing alignment timer for the configured grant-based SDT (e.g., TA-SDT timer) such that the configured grant SDT resources are valid again. Additionally, or alternatively, the timing alignment timer may be stopped.

As shown by reference number 645, the UE may transmit, and the base station may receive, a second uplink message including a UE ID and/or a BSR via one or more MAC CEs, as described herein. The UE ID may implicitly indicate that the UE is an SDT-configured UE. The second uplink message may further include a configured grant resource request, UE assistance information, and/or traffic pattern information (e.g., traffic associated with the UE), among other examples.

As shown by reference number 650, the UE may receive, and the base station may transmit, a network response to the first uplink message, as described herein. In some aspects, the network response may include a configured grant and/or a dynamic grant for the UE to transmit the uplink data (e.g., SDT-based data).

As shown by reference number 655 the UE may transmit, and the base station may receive, one or more subsequent transmissions of the uplink data, as described herein.

As shown by reference number 660, the UE may receive, and the base station may transmit, a release message, as described herein.

As indicated above, FIG. 6 is provided as an example. Other examples may differ from what is described with regard to FIG. 6.

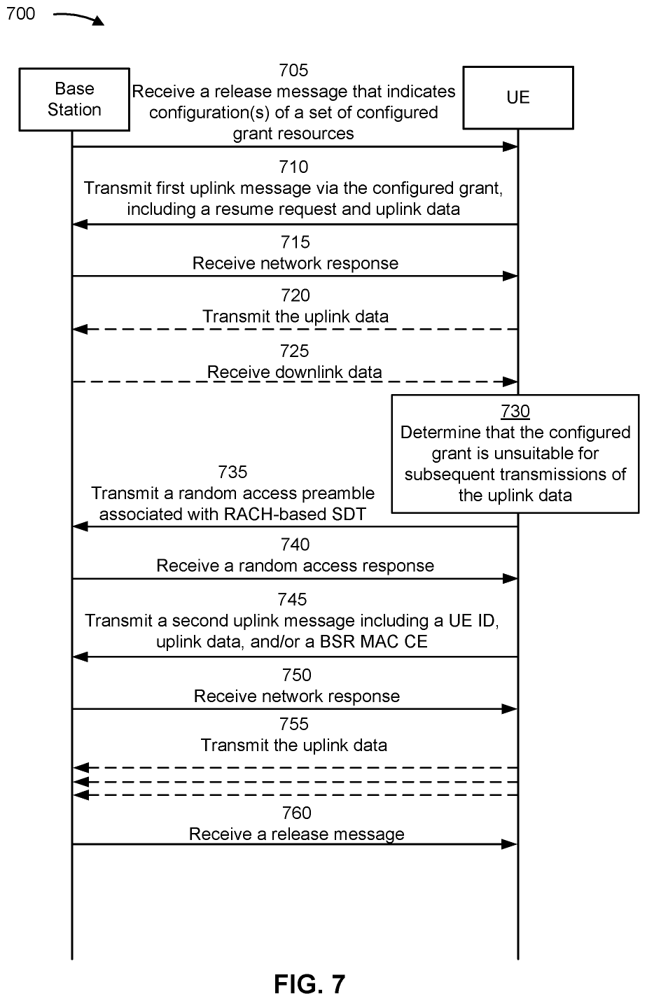

FIG. 7 is a diagram illustrating an example 700 associated with small data transfer communications, in accordance with the present disclosure. As shown in FIG. 7, a base station (e.g., base station 110) may communicate with a UE (e.g., UE 120). In some aspects, the base station and the UE may be part of a wireless network (e.g., wireless network 100). The UE and the base station may have established a wireless connection prior to operations shown in FIG. 7.

As shown by reference number 705, the UE may receive, and the base station may transmit, a release message that indicates one or more configurations of a set of configured grant resources, as described herein.

As shown by reference number 710, the UE may transmit, and the base station may receive, first uplink message via the configured grant, including a resume request message and uplink data, as described herein.

As shown by reference number 715, the UE may receive, and the base station may transmit, a network response, as described herein.

As shown by reference number 720, the UE may transmit, and the base station may receive, the uplink data, as described herein.

As shown by reference number 725, the UE may receive, and the base station may transmit, downlink data, as described herein.

As shown by reference number 730, the UE may determine that the configured grant is unsuitable for subsequent transmissions of the uplink data, as described herein.

As shown by reference number 735, the UE may transmit, and the base station may receive, a random access preamble associated with RACH-based SDT, as described herein. In some aspects, the UE checks criteria for selecting between a non-SDT RACH-based procedure and an SDT RACH-based procedure. The criteria may include an amount of available data for transmitting, whether the amount of available data satisfies a configured data volume threshold, and whether an RSRP satisfies a configured threshold. In some aspects, the UE selects the SDT RACH-based procedure based at least in part on the criteria, as described herein. The UE may transmit the random access preamble using a RACH resource that is dedicated for RACH-based SDT, including a dedicated RACH occasion and/or a dedicated PRACH resource.

The UE selects between a supplemental uplink (SUL) or a normal uplink (NUL) resource and/or a 2-step RACH or a 4-step RACH based at least in part on one or more parameters and/or a configuration of the network. In some aspects, the UE may skip an uplink carrier selection. For example, the UE may use a same carrier for the RACH-based SDT procedure that is used for the configured grant. Alternatively, the UE may perform uplink carrier selection to select a different uplink carrier for the RACH-based procedure than an uplink carrier configured for the configured grant.

As shown by reference number 740, the UE may receive, and the base station may transmit, a random access response, as described herein. After the UE receives the random access response (e.g., an RAR or a message B, among other examples), the UE may apply a timing advance command to start a timing alignment parameter for the RACH procedure. Based at least in part on receiving the random access response, the UE may restart a timing alignment timer for the configured grant-based SDT (e.g., TA-SDT timer) such that the configured grant SDT resources are valid again. Additionally, or alternatively, the timing alignment timer may be stopped.

As shown by reference number 745, the UE may transmit, and the base station may receive, a second uplink message including a UE ID and/or a BSR via one or more MAC CEs, as described herein. The UE ID may implicitly indicate that the UE is an SDT-configured UE. The second uplink message may further include a configured grant resource request, UE assistance information, and/or traffic pattern information (e.g., traffic associated with the UE), among other examples. The UE may not transmit a resume request message via the second uplink message (e.g., based at least in part on the UE already being registered with the network).

As shown by reference number 750, the UE may receive, and the base station may transmit, a network response to the second uplink message, as described herein. In some aspects, the network response may include a configured grant and/or a dynamic grant for the UE to transmit the uplink data (e.g., SDT-based data).

As shown by reference number 755 the UE may transmit, and the base station may receive, one or more subsequent transmissions of the uplink data, as described herein.

As shown by reference number 760, the UE may receive, and the base station may transmit, a release message, as described herein.

As indicated above, FIG. 7 is provided as an example. Other examples may differ from what is described with regard to FIG. 7.

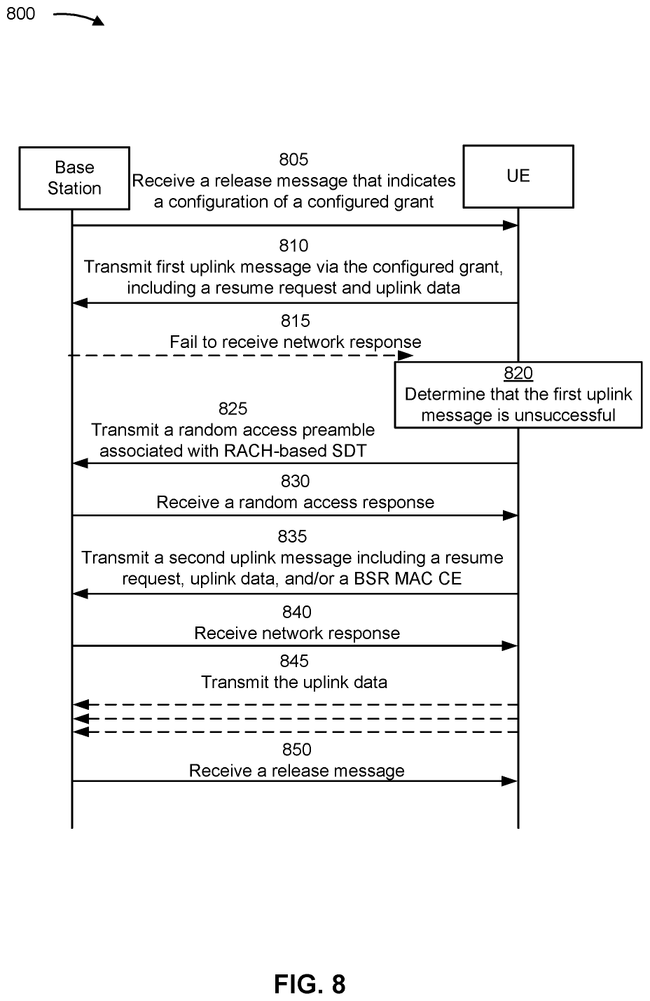

FIG. 8 is a diagram illustrating an example 800 associated with small data transfer communications, in accordance with the present disclosure. As shown in FIG. 8, a base station (e.g., base station 110) may communicate with a UE (e.g., UE 120). In some aspects, the base station and the UE may be part of a wireless network (e.g., wireless network 100). The UE and the base station may have established a wireless connection prior to operations shown in FIG. 8.

As shown by reference number 805, the UE may receive, and the base station may transmit, a release message that indicates one or more configurations of a set of configured grant resources, as described herein.

As shown by reference number 810, the UE may transmit, and the base station may receive, first uplink message via the configured grant, including a resume request message and uplink data, as described herein.

As shown by reference number 815, the UE may fail to receive a network response, as described herein. In some aspects, the UE may fail to receive the network response based at least in part on the base station failing to receive the first uplink message and/or based at least in part on the UE failing to receive the network response.

As shown by reference number 820, the UE may determine that the first uplink message is unsuccessful. In some aspects, the UE may determine that the first uplink message is unsuccessful based at least in part on receiving an indication from the base station, based at least in part on expiration of a monitoring window without receiving the network response, and/or observing a threshold number of failed transmissions of uplink messages using the configured grant resources.

As shown by reference number 825, the UE may transmit, and the base station may receive, a random access preamble associated with RACH-based SDT, as described herein. In some aspects, the UE checks criteria for selecting between a non-SDT RACH-based procedure and an SDT RACH-based procedure. The criteria may include an amount of available data for transmitting, whether the amount of available data satisfies a configured data volume threshold, and whether an RSRP satisfies a configured threshold. In some aspects, the UE selects the SDT RACH-based procedure based at least in part on the criteria, as described herein. The UE may transmit the random access preamble using a RACH resource that is dedicated for RACH-based SDT, including a dedicated RACH occasion and/or a dedicated PRACH resource.

The UE selects between a supplemental uplink (SUL) or a normal uplink (NUL) resource and/or a 2-step RACH or a 4-step RACH based at least in part on one or more parameters and/or a configuration of the network. In some aspects, the UE may skip an uplink carrier selection. For example, the UE may use a same carrier for the RACH-based SDT procedure that is used for the configured grant. Alternatively, the UE may perform uplink carrier selection to select a different uplink carrier for the RACH-based procedure than an uplink carrier configured for the configured grant.

As shown by reference number 830, the UE may receive, and the base station may transmit, a random access response, as described herein. After the UE receives the random access response (e.g., an RAR or a message B, among other examples), the UE may apply a timing advance command to start a timing alignment parameter for the RACH procedure. Based at least in part on receiving the random access response, the UE may restart a timing alignment timer for the configured grant-based SDT (e.g., TA-SDT timer) such that the configured grant SDT resources are valid again. Additionally, or alternatively, the timing alignment timer may be stopped.

As shown by reference number 835, the UE may transmit, and the base station may receive, a second uplink message including a resume request message, uplink data and/or a BSR via one or more MAC CEs, as described herein. The second uplink message may further include a configured grant resource request, UE assistance information, and/or traffic pattern information (e.g., traffic associated with the UE), among other examples. The UE may include a resume request message via the second uplink message (e.g., based at least in part on the first uplink message being unsuccessful).

As shown by reference number 840, the UE may receive, and the base station may transmit, a network response to the second uplink message, as described herein. In some aspects, the network response may include a configured grant and/or a dynamic grant for the UE to transmit the uplink data (e.g., SDT-based data).

As shown by reference number 845 the UE may transmit, and the base station may receive, one or more subsequent transmissions of the uplink data, as described herein.

As shown by reference number 850, the UE may receive, and the base station may transmit, a release message, as described herein.

As indicated above, FIG. 8 is provided as an example. Other examples may differ from what is described with regard to FIG. 8.

FIG. 9 is a diagram illustrating an example process 900 performed, for example, by a UE, in accordance with the present disclosure. Example process 900 is an example where the UE (e.g., UE 120) performs operations associated with SDT communications.

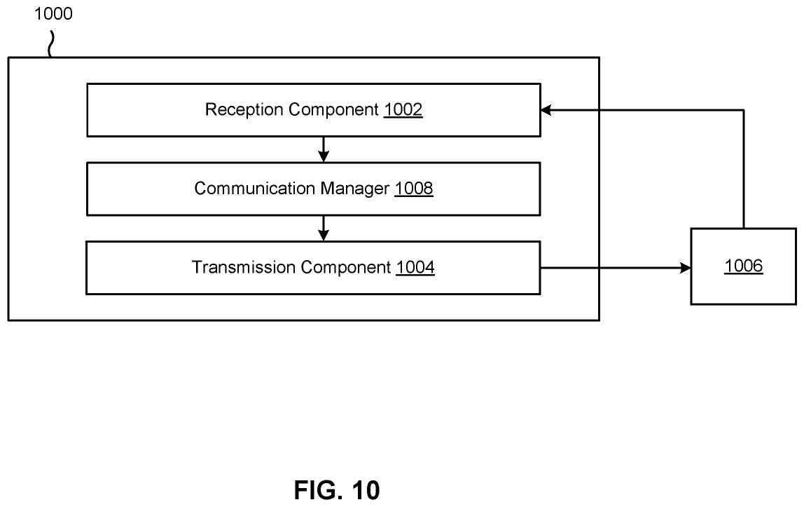

As shown in FIG. 9, in some aspects, process 900 may include transmitting an uplink message, via a configured grant, while the UE is in an inactive state, the uplink message including a request to resume a connection and uplink data (block 910). For example, the UE (e.g., using communication manager 140 and/or transmission component 1004, depicted in FIG. 10) may transmit an uplink message, via a configured grant, while the UE is in an inactive state, the uplink message including a request to resume a connection and uplink data, as described above.

As further shown in FIG. 9, in some aspects, process 900 may include initiating a RACH procedure based at least in part on the configured grant being unsuitable for subsequent transmissions of the uplink data (block 920). For example, the UE (e.g., using communication manager 140 and/or transmission component 1004, depicted in FIG. 10) may initiate a RACH procedure based at least in part on the configured grant being unsuitable for subsequent transmissions of the uplink data, as described above.

As further shown in FIG. 9, in some aspects, process 900 may include transmitting at least a portion of the uplink data via a message of the RACH procedure (block 930). For example, the UE (e.g., using communication manager 140 and/or transmission component 1004, depicted in FIG. 10) may transmit at least a portion of the uplink data via a message of the RACH procedure, as described above.

Process 900 may include additional aspects, such as any single aspect or any combination of aspects described below and/or in connection with one or more other processes described elsewhere herein.

In a first aspect, the configured grant is unsuitable for the subsequent transmissions of the uplink data based at least in part on one or more of a timing alignment value being invalid, a change in reference signal received power, failure to detect a qualified synchronization signal block before the subsequent transmissions of the uplink data, timing of a subsequent transmission occasion of the configured grant, a periodicity of transmission occasions of the configured grant, a latency requirement of the subsequent transmissions of the uplink data, a size of transmission occasions of the configured grant, an expected size of the subsequent transmissions of the uplink data, or a failure to receive a network response to the uplink message.

In a second aspect, alone or in combination with the first aspect, the RACH procedure comprises a 2-step RACH procedure, a 4-step RACH procedure, a SDT RACH procedure, or a non-SDT RACH procedure.

In a third aspect, alone or in combination with one or more of the first and second aspects, the message of the RACH procedure comprises an indication of an identification of the UE.

In a fourth aspect, alone or in combination with one or more of the first through third aspects, the message of the RACH procedure comprises a RACH message 3 or a RACH message A without a request to resume the connection.

In a fifth aspect, alone or in combination with one or more of the first through fourth aspects, process 900 includes receiving a random-access response, and stopping a timing alignment timer for the configured grant or restarting the timing alignment timer for the configured grant.

In a sixth aspect, alone or in combination with one or more of the first through fifth aspects, a resource associated with the configured grant is valid based at least in part on restarting the timing alignment timer for the configured grant.

In a seventh aspect, alone or in combination with one or more of the first through sixth aspects, process 900 includes selecting a RACH-based SDT procedure as the RACH procedure based at least in part on one or more of whether a size of the uplink data satisfies an SDT volume threshold, or whether a signal strength parameter satisfies an SDT signal strength threshold.

In an eighth aspect, alone or in combination with one or more of the first through seventh aspects, initiating the RACH procedure comprises using an uplink carrier configured the configured grant, or performing uplink carrier selection.

In a ninth aspect, alone or in combination with one or more of the first through eighth aspects, initiating the RACH procedure comprises using a RACH occasion or a physical RACH resource associated with the RACH-based SDT procedure.

In a tenth aspect, alone or in combination with one or more of the first through ninth aspects, the configured grant is unsuitable for the subsequent transmissions of the uplink data based at least in part on failure of the uplink message as determined based at least in part on one or more of an indication that the uplink message was not successfully received by a base station, a failure to receive a network response to the uplink message before expiration of a response timer, or satisfaction of a threshold number of failures of uplink messages using the configured grant.

In an eleventh aspect, alone or in combination with one or more of the first through ninth aspects, the message of the RACH procedure comprises a request to resume the connection based at least in part on the failure of the uplink message.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a communication manager 1008 (e.g., the communication manager 140).

In some aspects, the apparatus 1000 may be configured to perform one or more operations described herein in connection with FIGS. 5-8. Additionally, or alternatively, the apparatus 1000 may be configured to perform one or more processes described herein, such as process 900 of FIG. 9. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The transmission component 1004 may transmit an uplink message, via a configured grant, while the UE is in an inactive state, the uplink message including a request to resume a connection and uplink data. The transmission component 1004 may initiate a RACH procedure based at least in part on the configured grant being unsuitable for subsequent transmissions of the uplink data. The transmission component 1004 may transmit at least a portion of the uplink data via a message of the RACH procedure.

The reception component 1002 may receive a random-access response.

The communication manager 1008 may stop a timing alignment timer for the configured grant or restarting the timing alignment timer for the configured grant.

The communication manager 1008 may select a RACH-based SDT procedure as the RACH procedure based at least in part on one or more of whether a size of the uplink data satisfies an SDT volume threshold, or whether a signal strength parameter satisfies an SDT signal strength threshold.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a user equipment (UE), comprising: transmitting an uplink message, via a configured grant, while the UE is in an inactive state, the uplink message including a request to resume a connection and uplink data; and initiating a random access channel (RACH) procedure based at least in part on the configured grant being unsuitable for subsequent transmissions of the uplink data; and transmitting at least a portion of the uplink data via a message of the RACH procedure.
Aspect 2: The method of Aspect 1, wherein the configured grant is unsuitable for the subsequent transmissions of the uplink data based at least in part on one or more of: a timing alignment value being invalid, a change in reference signal received power, failure to detect a qualified synchronization signal block before the subsequent transmissions of the uplink data, timing of a subsequent transmission occasion of the configured grant, a periodicity of transmission occasions of the configured grant, a latency requirement of the subsequent transmissions of the uplink data, a size of transmission occasions of the configured grant, an expected size of the subsequent transmissions of the uplink data, or a failure to receive a network response to the uplink message.
Aspect 3: The method of any of Aspects 1-2, wherein the RACH procedure comprises: a 2-step RACH procedure, a 4-step RACH procedure, a small data transfer (SDT) RACH procedure, or a non-SDT RACH procedure.
Aspect 4: The method of any of Aspects 1-3, wherein the message of the RACH procedure comprises an indication of an identification of the UE.
Aspect 5: The method of any of Aspects 1-4, wherein the message of the RACH procedure comprises a RACH message 3 or a RACH message A without a request to resume the connection.
Aspect 6: The method of any of Aspects 1-5, further comprising: receiving a random-access response; and stopping a timing alignment timer for the configured grant or restarting the timing alignment timer for the configured grant.
Aspect 7: The method of Aspect 6, wherein a resource associated with the configured grant is valid based at least in part on restarting the timing alignment timer for the configured grant.
Aspect 8: The method of any of Aspects 1-7, further comprising: selecting a RACH-based small data transfer (SDT) procedure as the RACH procedure based at least in part on one or more of: whether a size of the uplink data satisfies an SDT volume threshold, or whether a signal strength parameter satisfies an SDT signal strength threshold.
Aspect 9: The method of Aspect 8, wherein initiating the RACH procedure comprises: using an uplink carrier configured the configured grant, or performing uplink carrier selection.
Aspect 10: The method of any of Aspects 8-9, wherein initiating the RACH procedure comprises: using a RACH occasion or a physical RACH resource associated with the RACH-based SDT procedure.
Aspect 11: The method of any of Aspects 1-10, wherein the configured grant is unsuitable for the subsequent transmissions of the uplink data based at least in part on failure of the uplink message as determined based at least in part on one or more of: an indication that the uplink message was not successfully received by a base station, a failure to receive a network response to the uplink message before expiration of a response timer, or satisfaction of a threshold number of failures of uplink messages using the configured grant.
Aspect 12: The method of Aspect 11, the message of the RACH procedure comprises a request to resume the connection based at least in part on the failure of the uplink message.
Aspect 13: An apparatus for wireless communication at a device, comprising a processor; memory coupled with the processor; and instructions stored in the memory and executable by the processor to cause the apparatus to perform the method of one or more of Aspects 1-12.
Aspect 14: A device for wireless communication, comprising a memory and one or more processors coupled to the memory, the one or more processors configured to perform the method of one or more of Aspects 1-12.
Aspect 15: An apparatus for wireless communication, comprising at least one means for performing the method of one or more of Aspects 1-12.
Aspect 16: A non-transitory computer-readable medium storing code for wireless communication, the code comprising instructions executable by a processor to perform the method of one or more of Aspects 1-12.
Aspect 17: A non-transitory computer-readable medium storing a set of instructions for wireless communication, the set of instructions comprising one or more instructions that, when executed by one or more processors of a device, cause the device to perform the method of one or more of Aspects 1-12.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. Software shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code-it being understood that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
one or more memories; and
one or more processors coupled to the one or more memories, the one or more memories comprising instructions executable by the one or more processors to cause the UE to:
transmit an uplink message, via a configured grant, while the UE is in an inactive state, the uplink message including a request to resume a connection and uplink data;
initiate a random access channel (RACH) procedure based at least in part on the configured grant being unsuitable for subsequent transmissions of the uplink data; and
transmit at least a portion of the uplink data via a message of the RACH procedure.

2. The UE of claim 1, wherein the configured grant is unsuitable for the subsequent transmissions of the uplink data based at least in part on one or more of:
a timing alignment value being invalid,
a change in reference signal received power,
failure to detect a qualified synchronization signal block before the subsequent transmissions of the uplink data,
timing of a subsequent transmission occasion of the configured grant,
a periodicity of transmission occasions of the configured grant,
a latency requirement of the subsequent transmissions of the uplink data,
a size of transmission occasions of the configured grant,
an expected size of the subsequent transmissions of the uplink data, or
a failure to receive a network response to the uplink message.

3. The UE of claim 1, wherein the RACH procedure comprises:
a 2-step RACH procedure,
a 4-step RACH procedure,
a small data transfer (SDT) RACH procedure, or
a non-SDT RACH procedure.

4. The UE of claim 1, wherein the message of the RACH procedure comprises an indication of an identification of the UE.

5. The UE of claim 1, wherein the message of the RACH procedure comprises a RACH message 3 or a RACH message A without a request to resume the connection.

6. The UE of claim 1, wherein the one or more memories further comprises instructions executable by the one or more processors to cause the UE to:
receive a random-access response; and
stop a timing alignment timer for the configured grant or restarting the timing alignment timer for the configured grant.

7. The UE of claim 6, wherein a resource associated with the configured grant is valid based at least in part on restarting the timing alignment timer for the configured grant.

8. The UE of claim 1, wherein the one or more memories further comprises instructions executable by the one or more processors to cause the UE to:
select a RACH-based small data transfer (SDT) procedure as the RACH procedure based at least in part on one or more of:
whether a size of the uplink data satisfies an SDT volume threshold, or
whether a signal strength parameter satisfies an SDT signal strength threshold.

9. The UE of claim 8, wherein the instructions, executable to cause the UE to initiate the RACH procedure, are executable to cause the UE to:
use an uplink carrier configured the configured grant, or
perform uplink carrier selection.

10. The UE of claim 8, wherein the instructions, executable to cause the UE to initiate the RACH procedure, are executable to cause the UE to:
use a RACH occasion or a physical RACH resource associated with the RACH-based SDT procedure.

11. The UE of claim 1, wherein the configured grant is unsuitable for the subsequent transmissions of the uplink data based at least in part on failure of the uplink message as determined based at least in part on one or more of:
an indication that the uplink message was not successfully received by a base station,
a failure to receive a network response to the uplink message before expiration of a response timer, or
satisfaction of a threshold number of failures of uplink messages using the configured grant.

12. The UE of claim 11, the message of the RACH procedure comprises a request to resume the connection based at least in part on the failure of the uplink message.

13. A method of wireless communication performed by a user equipment (UE), comprising:
transmitting an uplink message, via a configured grant, while the UE is in an inactive state, the uplink message including a request to resume a connection and uplink data;
initiating a random access channel (RACH) procedure based at least in part on the configured grant being unsuitable for subsequent transmissions of the uplink data; and
transmitting at least a portion of the uplink data via a message of the RACH procedure.

14. The method of claim 13, wherein the configured grant is unsuitable for the subsequent transmissions of the uplink data based at least in part on one or more of:
a timing alignment value being invalid,
a change in reference signal received power,
failure to detect a qualified synchronization signal block before the subsequent transmissions of the uplink data,
timing of a subsequent transmission occasion of the configured grant,
a periodicity of transmission occasions of the configured grant,
a latency requirement of the subsequent transmissions of the uplink data,
a size of transmission occasions of the configured grant,
an expected size of the subsequent transmissions of the uplink data, or
a failure to receive a network response to the uplink message.

15. The method of claim 13, wherein the RACH procedure comprises:
a 2-step RACH procedure,
a 4-step RACH procedure,
a small data transfer (SDT) RACH procedure, or
a non-SDT RACH procedure.

16. The method of claim 13, wherein the message of the RACH procedure comprises an indication of an identification of the UE.

17. (canceled)

18. The method of claim 13, further comprising:
receiving a random-access response; and
stopping a timing alignment timer for the configured grant or restarting the timing alignment timer for the configured grant.

19-24. (canceled)

25. A non-transitory computer-readable medium storing one or more instructions for wireless communication, the one or more instructions, when executed by one or more processors of a user equipment (UE), cause the UE to:
transmit an uplink message, via a configured grant, while the UE is in an inactive state, the uplink message including a request to resume a connection and uplink data;
initiate a random access channel (RACH) procedure based at least in part on the configured grant being unsuitable for subsequent transmissions of the uplink data; and
transmit at least a portion of the uplink data via a message of the RACH procedure.

26. The non-transitory computer-readable medium of claim 25, wherein the message of the RACH procedure comprises an indication of an identification of the UE.

27. The non-transitory computer-readable medium of claim 25, wherein the message of the RACH procedure comprises a RACH message 3 or a RACH message A without a request to resume the connection.

28-30. (canceled)
